(19) United States
(12) Patent Application Publication
(10) Pub. No.: US 2006/0057466 A1
(43) Pub. Date: Mar. 16, 2006

(54) Composite oxide containing lithum, nickel, cobalt, manganese, and fluorine, process for producing the same, and lithium secondary cell employing it

(75) Inventors: Manabu Suhara, Chigasaki-shi, Kanagawa-ken (JP); Takuya Mihara, Chigasaki-shi (JP); Sumitoshi Yajima, Chigasaki-shi (JP); Koichiro Ueda, Chigasaki-shi (JP); Yukimitsu Wakasugi, Chigasaki-shi (JP)

Correspondence Address: KANESAKA BERNER AND PARTNERS LLP, SUITE 300, 1700 DIAGONAL RD, ALEXANDRIA, VA, 22314-2848, US

(73) Assignee: Seimi Chemical Co., Ltd., Chigasaki-shi, Kanagawa-ken (JP)

(21) Appl. No.: 10/535,855

(22) PCT Filed: Jul. 7, 2004
(86) PCT No.: PCT/JP04/09648

§ 371 Date: May 20, 2005

(30) Foreign Application Priority Data
Sep. 16, 2003 (JP) 2003-323321

(51) Int. Cl. H01M 6/18

(52) U.S. Cl. 429/322

(57) ABSTRACT

There is obtained an active material for a lithium secondary battery that has a wide usable voltage range, a high charge-discharge cycle durability, a high capacity and high safety and availability.

The particles of a lithium-nickel-cobalt-manganese-fluorine-containing composite oxide having an R-3m rhombohedral structure represented by a general formula LiₚNiₓMn_{1-x-y}Co_{y}O_{2-q}F_{q} (where 0.98≦p≦1.07, 0.3≦x≦0.5, 0.1≦y≦0.38, and 0≦q≦0.05), and the particles of the lithium-nickel-cobalt-manganese-fluorine-containing composite oxide characterized in that the half-width of the diffraction peak of a (110) plane whose 2θ is 65±0.5° in the X-ray diffraction using a Cu—Kα line is, 0.12 to 0.25° are used as an active substance for a positive electrode.

### TECHNICAL FIELD

The present invention relates to an improved lithium-nickel-cobalt-manganese-fluorine-containing composite oxide used as the active material for the positive electrode of a lithium secondary battery, a method for the preparation thereof, and a lithium secondary battery using the same.

### BACKGROUND ART

With recent progress of portable and cordless devices, expectation to small and light non-aqueous electrolyte secondary batteries having high energy density has increased. As active substances for non-aqueous electrolyte secondary batteries, composite oxides of lithium and a transition metal, such as LiCoO₂, LiNiO₂, LiMn₂O₄ and LiMnO₂, have been known.

Among them, particularly in recent years, studies on a composite oxide of lithium and manganese as highly safe and inexpensive materials, have been actively conducted, and the development of non-aqueous electrolyte secondary batteries of high voltage and high energy density by combining these composite oxides with a negative electrode active substance, such as a carbonaceous material that can store and discharge lithium, has been advanced.

In general, a positive electrode active substance used in a non-aqueous electrolyte secondary battery is composed of a composite oxide wherein a transition metal, such as cobalt, nickel and manganese, forms solid solution with lithium, which is the main active material, and depending on the kind of the transition metal, the electrode properties, such as electrical capacity, reversibility, operating voltage and safety, differ.

For example, a non-aqueous electrolyte secondary battery using an R-3m rhombohedral rock-salt-like composite oxide wherein cobalt or nickel forms solid solution, such as LiCoO₂ and LiNi_{0.8}Co_{0.2}O₂ as the positive electrode active substance can achieve as relatively high capacity density as 140 to 160 mAh/g and 180 to 200 mAh/g, respectively; and exhibits a high reversibility at as a high-voltage region as 2.7 to 4.3 V.

However, there are problems that a battery generates heat easily due to the reaction of a positive electrode active material with the solvent of an electrolyte solution during charging when the battery is heated, and that the costs of the active material increase because material cobalt and nickel are expensive.

In Patent Document 1, for example, LiNi_{0.75}Co_{0.20}Mn_{0.05}O₂ is proposed for improving the properties of LiNi_{0.8}Co_{0.2}O₂, and a method for preparing the intermediate of the positive electrode active material using an ammonium complex is disclosed. In Patent Document 2, a method for preparing a nickel-manganese binary hydroxide material for a lithium battery having a specific particle-size distribution using a chelating agent is proposed. However, in both the references, positive electrode active materials that can simultaneously satisfy the three of charge-discharge capacity, cycle durability and safety cannot be obtained.

In Patent Document 3 and Patent Document 4, the use of a co-precipitated nickel-cobalt-manganese hydroxide as the material for nickel-cobalt-manganese-containing composite oxide is proposed. However, there was a problem when a desired lithium-nickel-cobalt-manganese-containing composite oxide was prepared by allowing co-precipitated nickel-cobalt-manganese hydroxide to react with a lithium compound that if lithium hydroxide was used as the lithium compound, the reaction with lithium proceeded relatively quickly; however, when lithium hydroxide was used, sintering proceeded excessively when a single-step firing at 800 to 1000° C. was carried out, a uniform reaction with lithium was difficult, and the initial charge-discharge efficiency, initial discharge capacity, and charge-discharge cycle durability of the obtained lithium-containing composite oxide were poor.

In order to avoid this, it was necessary to perform firing once at 500 to 700° C., and after crushing the fired body, to further perform firing at 800 to 1000° C. There was also a problem that not only lithium hydroxide was more expensive than lithium carbonate, but also the costs for intermediate crushing, multi-step firing and the like was high. On the other hand, when inexpensive lithium carbonate was used as the lithium compound, the reaction with lithium was slow, and it was difficult to prepare a lithium-nickel-cobalt-manganese-containing composite oxide having desired battery properties industrially.

In Patent Document 5, a method wherein a nickel-manganese-cobalt composite hydroxide is fired at 400° C. for 5 hours, and after mixing with lithium hydroxide, firing is performed, is proposed. However, since this synthesizing method includes the step for firing the material hydroxide, there are drawbacks that the process becomes complicated, the cost of preparation becomes high, and lithium hydroxide of high material costs is used.

In Patent Document 6, a method wherein a nickel-manganese-cobalt composite hydroxide is mixed with lithium hydroxide, and then firing is performed, is proposed. The reference describes that lithium hydroxide is more advantageous than lithium carbonate in the aspects of the control of particle forms and the control of crystallinity. A method wherein a nickel-manganese-cobalt composite hydroxide is oxidized, and after mixing with lithium hydroxide, firing is performed, is proposed. However, both the methods have drawbacks to use lithium hydroxide of high material costs.

On the other hand, although a non-aqueous electrode secondary battery using a spinel-type composite oxide consisting of LiMn₂O₄ formed from relatively inexpensive manganese as the material is relatively difficult to generate heat due to the reaction of the positive electrode active material with the solvent of the electrolyte during charging, there are problems that the capacity is as low as 100 to 120 mAh/g compared with the cobalt-based and nickel-based active materials, and charge-discharge cycle durability is poor, as well as the problem that the secondary battery is rapidly deteriorated in a low-voltage region of lower than 3 V.

In addition, although a battery using LiMnO₂ of rhombic Pmnm system or monoclinic C2/m system, LiMn_{0.95}Cr_{0.05}O₂, LiMn_{0.9}Al_{0.1}O₂ or the like has high safety, and there are examples wherein a high initial capacity is developed, there are problems that change in crystal structure occurs easily associated with charge-discharge cycles, and cycle durability becomes insufficient.
[Patent Document 1] Japanese Patent Application Publication No. 10-27611
[Patent Document 2] Japanese Patent Application Publication No. 10-81521
[Patent Document 3] Japanese Patent Application Publication No. 2002-201028
[Patent Document 4] Japanese Patent Application Publication No. 2003-59490
[Patent Document 5] Japanese Patent Application Publication No. 2003-86182
[Patent Document 6] Japanese Patent Application Publication No. 2003-17052

### DISCLOSURE OF THE INVENTION

The present invention has been devised to solve such problems, and the object thereof is to provide a positive electrode material for a non-aqueous electrolyte secondary battery that can be prepared by a simple preparing process using an inexpensive lithium source, and when used in a lithium secondary battery as an active material, a battery that can be used in a wide voltage range, that has a high initial charge-discharge efficiency, a high weight capacity density and a high volume capacity density, that excels in large-current discharge properties, and that has a high safety can be obtained.

In order to achieve the object, the present invention provides a lithium-nickel-cobalt-manganese-fluorine-containing composite oxide having an R-3m rhombohedral structure represented by a general formula LiₚNiₓMn_{1-x-y}Co_{y}O₂₋ₚF_{q} (where 0.98≦p≦1.07, 0.3≦x≦0.5, 0.1≦y≦0.38, and 0≦q≦0.05), characterized in that the half-width of the diffraction peak of a (110) plane whose 2θ is 65±0.5° in the X-ray diffraction using a Cu—Kα line is 0.12 to 0.25°.

The half-width of the diffraction peak of a (110) plane smaller than 0.12° is not preferable, because the crystal grown excessively, resulting in the lowering of the specific surface area and the lowering of the large-current discharge properties. The half-width of the diffraction peak of a (110) plane larger than 0.25° is also not preferable, because the crystallinity is lowered, the initial charge-discharge efficiency is lowered, the large-current discharge properties are lowered, the weight discharge capacity density is lowered, or the compressed density of the positive electrode powder is lowered, resulting in the lowering of the discharge capacity density per unit volume, or the lowering of safety.

It is preferable that the half-width of the diffraction peak of a (110) plane is 0.15 to 0.22°. As the particles of the composite oxide of the present invention, in the X-ray diffraction using a Cu—Kα line, it is preferable that the half-width of the diffraction peak of a (003) plane is 0.10 to 0.16°, especially 0.13 to 0.155°.

The present invention also provides the particles of a lithium-nickel-cobalt-manganese-fluorine-containing composite oxide, wherein the specific surface area is 0.3 to 1.0 m²/g. The specific surface area smaller than 0.3 m²/g is not preferable because the large-current discharge properties are lowered, and the specific surface area larger than 1.0 m²/g is not preferable because the filling properties of the positive electrode powder are lowered, and the volume capacity density is lowered. The preferable range of the specific surface area is 0.4 to 0.8 m²/g.

In a lithium-nickel-cobalt-manganese-fluorine-containing composite oxide of the present invention, fluorine is contained in order to improve safety, initial charge-discharge efficiency, and further, large-current discharge properties; however, it is important that q is 0.05 or less. It is not preferable that q exceeds 0.05, because the initial weight capacity density is lowered. It is not preferable that q is excessively low, because the effect to improve safety is lowered, the volume capacity density is lowered, the initial charge-discharge efficiency is lowered, the large-current discharge properties are lowered, and the initial weight capacity density is lowered. The preferable range of q is 0.001 to 0.02. In the present invention, it is preferable that fluorine atoms are eccentrically located on the outer-layer portion of the lithium-nickel-cobalt-manganese-fluorine-containing composite oxide. The presence of the fluorine atoms evenly in the particles of the composite oxide is not preferable because the effect of the present invention is difficult to develop.

It is preferable that the powder compressed density of the lithium-nickel-cobalt-manganese-fluorine-containing composite oxide of the present invention is 2.6 g/cm³ or more, especially 2.9 to 3.4 g/cm³, whereby, when a binder and a solvent are mixed to the powder of the active material to prepare a slurry, and the slurry is applied to an collector formed of aluminum foil, dried and compressed, the capacity per a unit volume can be elevated. In the present invention, the compressed density of the particles of the lithium-containing composite oxide is 0.96 t/cm², which is the apparent packed density when compressed.

It is preferable that the compressive breaking strength (hereafter may be abbreviated simply as breaking strength) of the lithium-nickel-cobalt-manganese-fluorine-containing composite oxide of the present invention is 50 MPa or more. The breaking strength of less than 50 MPa is not preferable because the filling properties of the electrode layer lowers when a positive electrode layer is formed, resulting in the lowering of the volume capacity density. The preferable range of the breaking strength is 80 to 300 MPa. Such a breaking strength (St) is the value obtained using the equation of Hiramatsu et al. (Journal of the Mining and Metallurgical Institute of Japan, Vol. 81, No. 932, December 1965, pp. 1024-1030) shown in the following equation (1):
St=2.8 P/π d² (d: particle diameter, P: load on particles) Eq (1)

The lithium-nickel-cobalt-manganese-fluorine-containing composite oxide of the present invention can improve the battery properties, such as safety, initial discharge capacity and large-current discharge characteristics by further substituting a part of nickel, cobalt and manganese with other metal elements. As the other metal elements, aluminum, magnesium, zirconium, titanium, tin, silicon and tungsten are exemplified, and aluminum, magnesium, zirconium and titanium are especially preferable. As the quantity to be substituted, 0.1 to 10% of the total number of nickel, cobalt and manganese atoms is suitable.

The present invention provides a lithium secondary battery characterized in using the lithium-nickel-cobalt-manganese-fluorine-containing composite oxide in the positive electrode.

The present invention also provides a method for preparing a lithium-nickel-cobalt-manganese-fluorine-containing composite oxide, characterized by including a step for dry-blending the agglomerated particles of a nickel-cobalt-manganese composite oxyhydroxide, lithium carbonate and a fluorine-containing compound, and a step for firing them in an oxygen-containing atmosphere.

The present invention provides a method for preparing the lithium-nickel-cobalt-manganese-fluorine-containing composite oxide, wherein the specific surface area of the nickel-cobalt-manganese agglomerated composite oxyhydroxide is 4 to 30 m²/g.

The present invention also provides a method for preparing the lithium-nickel-cobalt-manganese-fluorine-containing composite oxide, wherein the powder compressed density of nickel-cobalt-manganese-containing agglomerated composite oxyhydroxide is 2.0 g/cm³ or more.

The present invention also provides a method for preparing the lithium-nickel-cobalt-manganese-fluorine-containing composite oxide, wherein the half-width of the diffraction peak of the agglomerated particles of a nickel-cobalt-manganese agglomerated composite oxyhydroxide whose 2θ is 19±1° in the X-ray diffraction using a Cu—Kα line, is 0.3 to 0.5°.

On the other hand, the present invention also provides a lithium secondary battery characterized in that a lithium-nickel-cobalt-manganese-fluorine-containing composite oxide prepared using the preparing method is used as the positive electrode.

The lithium-containing composite oxide of the present invention can be produced by a simple producing process using an inexpensive lithium source, and when it is used in a lithium secondary battery as an active material, the battery that can be used in a wide voltage range, that has a high initial charge-discharge efficiency, an high weight capacity density and a high volume capacity density, excels in large-current discharge characteristics, and has a high safety can be obtained.

### BEST MODE FOR CARRYING OUT THE INVENTION

The lithium-nickel-cobalt-manganese-fluorine-containing composite oxide of the present invention is particulate, and has the composition represented by a general formula LiₚNiₓMn_{1-x-y}Co_{y}O_{2-q}F_{q} (where 0.98≦p≦1.07, 0.3≦x≦0.5, 0.1≦y≦0.38, and 0≦q≦0.05).

In the above general formula, if p is less than 0.98, the discharge capacity lowers, and if p exceeds 1.07, the discharge capacity lowers, the generation of gas in the battery increases during charging, both of which are disadvantageous. Since a stable R-3m rhombohedral structure cannot be formed if x is less than 0.3, and safety is lowered if x exceeds 0.5, these cannot be adopted. The preferable range of x is 0.32 to 0.42. If y is less than 0.1, the initial charge-discharge efficiency and the large-current discharge characteristics lower, and if y exceeds 0.38, safety lowers, both of which are not preferable. The preferable range of y is 0.23 to 0.35.

In the present invention, it is preferable that the atomic ratio of nickel and manganese is 1±0.05, from the point of view to improve battery characteristics.

It is also preferable that the crystal structure of the lithium-containing composite oxide according to the present invention is an R-3m rhombohedral structure. A highly crystalline lithium-containing composite oxide according to the present invention characterized in the half-width of the diffraction peak of the (110) plane is also characterized in a high powder compressed density.

In an aspect of the producing method of the present invention, an aqueous solution of a nickel-cobalt-manganese salt, an aqueous solution of an alkali metal hydroxide, and an ammonium ion supplier are continuously or intermittently supplied to the reaction system, the reaction is conducted in the state wherein the temperature of the reaction system is adjusted to be substantially constant within the range between 30 and 70° C., and pH is maintained at a substantially constant value within the range between 10 and 13, to synthesize the particles of a nickel-cobalt-manganese composite hydroxide wherein primary particles of a nickel-cobalt-manganese composite hydroxide are agglomerated to form secondary particles; and the agglomerated particles of a nickel-cobalt-manganese composite oxyhydroxide obtained by allowing an oxidant to react with the above composite hydroxide are mixed with lithium carbonate and a fluorine-containing compound, and fired to synthesize a lithium-nickel-cobalt-manganese-fluorine composite oxide.

As an aqueous solution of the nickel-cobalt-manganese salt used for the synthesis of the above agglomerated particles of a nickel-cobalt-manganese composite hydroxide, a mixed aqueous solution of sulfates, a mixed aqueous solution of nitrates, a mixed aqueous solution of oxalates, a mixed aqueous solution of chlorides or the like is exemplified. It is preferable that the concentration of the metal salts in the mixed aqueous solution of the nickel-cobalt-manganese salt supplied to the reaction system is 0.5 to 2.5 mol/L (liter) in total.

As an aqueous solution of an alkali metal hydroxide supplied to the reaction system, an aqueous solution of sodium hydroxide, an aqueous solution of potassium hydroxide, and an aqueous solution of lithium hydroxide are preferably exemplified. It is preferable that the concentration of the aqueous solution of the alkali metal hydroxide is 15 to 35 mol/L.

An ammonium-ion supplier is required to obtain dense and spherical composite hydroxide, because the ammonium-ion supplier forms a complex salt with nickel or the like. As the ammonium-ion supplier, ammonia water, an aqueous solution of ammonium sulfate or ammonium nitrate is preferably exemplified. It is preferable that the concentration of ammonia or ammonium ions is 2 to 20 mol/L.

A method for producing the agglomerated particles of a nickel-cobalt-manganese composite hydroxide will be more specifically described. A mixed aqueous solution of a nickel-cobalt-manganese salt, an aqueous solution of an alkali metal hydroxide, and an ammonium-ion supplier are continuously or intermittently supplied to a reaction vessel, the temperature of the slurry in the reaction vessel is controlled to a constant temperature (variation width: ±2° C., preferably±0.5° C.) within the rage between 30 and 70° C. while vigorously stirring the slurry in the reaction vessel. If the temperature is below 30° C., the precipitating reaction is retarded, and spherical particles are difficult to obtain. The temperature exceeding 70° C. is not preferable because much energy is required. As especially preferable temperature, a constant temperature within the rage between 40 and 60° C. is selected.

The pH of the slurry in the reaction vessel is maintained to be a constant pH (variation width: ±0.1, preferably±0.05) within the rage between 10 and 13 by controlling the supply rate of the aqueous solution of an alkali metal hydroxide. The pH lower than 10 is not preferable because the crystal is excessively grown. The pH exceeding 13 is not preferable because ammonia is easily evaporated and the quantity of fine particles increases.

The retention time in the reaction vessel is preferably 0.5 to 30 hours, and more preferably 5 to 15 hours. The slurry concentration is preferably 500 to 1200 g/L. The slurry concentration lower than 500 g/L is not preferable, because the filling properties of the formed particles are lowered. The slurry concentration exceeding 1200 g/L is not preferable, because the stirring of the slurry becomes difficult. The nickel-ion concentration in the slurry is 100 ppm or less, and more preferably 30 ppm or less. The excessively high nickel-ion concentration is not preferable because the crystal is excessively grown.

By properly controlling the temperature, pH, retention time, slurry concentration, and ion concentration in the slurry, the agglomerated particles of a nickel-cobalt-manganese composite hydroxide having a desired average particle diameter, particle-diameter distribution, and particle density can be obtained. The dense, spherical intermediate having an average particle diameter of 4 to 12 μm and preferable particle-size distribution can be obtained using a multi-stage reaction method rather than a single-stage reaction method.

By continuously or intermittently supplying a mixed aqueous solution of a nickel-cobalt-manganese salt, an aqueous solution of an alkali metal hydroxide, and an ammonium-ion supplier to a reaction vessel, continuously or intermittently overflowing or extracting the particles of the nickel-cobalt-manganese composite hydroxide formed by the reaction, and filtering and washing them with water, a powdery (particulate) nickel-cobalt-manganese composite hydroxide can be obtained. A part of the formed particles of the nickel-cobalt-manganese composite hydroxide can be fed back to the reaction vessel for controlling the properties of the formed particles.

The agglomerated particles of a nickel-cobalt-manganese composite oxyhydroxide can be obtained by allowing an oxidant to react with the above agglomerated particles of a nickel-cobalt-manganese composite hydroxide. Specifically, the agglomerated particles of a nickel-cobalt-manganese composite oxyhydroxide can be synthesized by making an oxidant, such as dissolved air, coexist in the slurry in the reaction vessel for synthesizing a nickel-cobalt-manganese composite hydroxide, or by dispersing a nickel-cobalt-manganese composite hydroxide in the aqueous solution to be a slurry, supplying air, sodium hypochlorite, hydrogen peroxide, potassium persulfate, bromine or the like and allowing it to react at 10 to 60° C. for 5 to 20 hours, and filtering and water-washing the obtained agglomerated particles of the composite oxyhydroxide. When sodium hypochlorite, potassium persulfate, bromine or the like is used as the oxidant, a hydroxidized Niₓ.Mn_{1-x-y}.Co_{y}OOH co-precipitate having an average metal valence of about 3 can be obtained.

It is preferable that the powder compressed density of the agglomerated particles of the nickel-cobalt-manganese composite oxyhydroxide is 2.0 g/cm³ or more. The powder compressed density less than 2.0 g/cm³ is not preferable because it is difficult to raise the powder compressed density when the nickel-cobalt-manganese composite oxyhydroxide is fired together with a lithium salt. The especially preferable powder compressed density is 2.2 g/cm³ or more. It is desirable that the agglomerated particles of the nickel-cobalt-manganese composite oxyhydroxide are substantially spherical, and the average particle diameter D50 is preferably 3 to 15 μm.

It is preferable that the average valence of the metal of the above agglomerated particles of the nickel-cobalt-manganese composite oxyhydroxide is 2.6 or more. The average valence less than 2.6 is not preferable because the reaction rate with lithium carbonate is lowered. The especially preferable average valence is 2.8 to 3.2. In the present invention, lithium carbonate is preferably of powder having an average particle size of 1 to 50 μm.

Although the reason why the volume capacity density of the positive electrode can be increased by increasing the compressive breaking strength of the powder of the lithium-nickel-cobalt-manganese composite oxide is not necessarily clear, it is substantially estimated as follows:

When a positive electrode is formed by compressing the agglomerated powder of a lithium-nickel-cobalt-manganese composite oxide, if the compression breaking strength of the powder is high, the compression stress energy produced by compression is not used for breaking the powder; therefore, as a result that the compression stress acts to each powder as it is, dense packing can be achieved by the slippage of the particles composing the powder against each other. On the other hand, if the compression breaking strength of the powder is low, the compression stress energy is used for breaking the powder; therefore, it is considered that since the pressure on the particles forming each powder is lowered, and dense packing by the slippage of the particles against each other is difficult to occur, the density of the positive electrode cannot be improved.

The especially preferable powder compressed density of the lithium-nickel-cobalt-manganese composite oxide of the present invention is 2.9 g/cm³ or more. Besides the high crystallinity of the present invention, the powder compressed density of 2.9 g/cm³ or more can also be achieved by optimizing the particle-diameter distribution of the powder. Specifically, the density can be raised by widening the particle-diameter distribution so that the volume fraction of the small-diameter particles is 20 to 50%, and the particle-diameter distribution of the large-diameter particles is narrowed.

In lithium-nickel-cobalt-manganese-fluorine-containing composite oxide of the present invention, a mixture wherein a fluorine compound is added in addition to the lithium compound is used for firing. As the fluorine compound, lithium fluoride, ammonium fluoride, magnesium fluoride, nickel fluoride, and cobalt fluoride can be exemplified. A fluorinating agent, such as fluorine chloride, fluorine gas, hydrogen fluoride gas, nitrogen trifluoride, can also be allowed to react.

The lithium-nickel-cobalt-manganese-containing composite oxide of the present invention can be obtained, for example, by firing the mixture of the powder of the nickel-cobalt-manganese composite oxyhydroxide and the powder of a lithium compound using a solid-phase method in an oxygen-containing atmosphere at 800 to 1050° C. for 4 to 40 hours. Firing may be performed using multi-stage firing as required.

The lithium-containing composite oxide for a lithium secondary battery has an R-3m rhombohedral structure, and exerts excellent charge-discharge cycle stability as an active material. It is preferable that the firing atmosphere is an oxygen-containing atmosphere, and thereby, high-performance battery properties can be obtained. Although the reaction with lithium itself proceeds in the air, for improving the battery properties, the oxygen concentration is preferably 25% or more, and more preferably 40% or more.

By mixing a carbonaceous conducting material, such as acetylene black, graphite and kitchen black, and a binder to the powder of the lithium-containing composite oxide of the present invention, a positive electrode compound is formed. As the binder, polyvinylidene fluoride, polytetrafluoroethylene, polyamide, carboxymethyl cellulose, an acrylic resin, or the like can be used. Slurry consisting of the powder of the lithium-containing composite oxide of the present invention, the binder, and the solvent or dispersant of the binder is applied to a positive electrode collector, such as an aluminum foil, dried and compressed to form a layer of a positive electrode active material on the positive electrode collector.

In the lithium battery having the layer of the positive electrode active material, a carbonate ester is preferably adopted as the solvent of the electrolyte solution. Either cyclic or chain carbonate ester can be used. As cyclic carbonate esters, propylene carbonate, ethylene carbonate (EC) and the like can be exemplified. As chain carbonate esters, dimethyl carbonate, diethyl carbonate (DEC), ethylmethyl carbonate, methylpropyl carbonate, methylisopropyl carbonate and the like can be exemplified.

The carbonate esters can be used alone, or can be used in combination of two or more. They can also be used by mixing with other solvents. Depending on the kind of the negative electrode active materials, there is a case wherein the discharging characteristics, cycle durability, and charge-discharge efficiency can be improved when a chain carbonate ester and a cyclic carbonate ester are used in combination. A vinylidene fluoride-hexafluoropropylene copolymer, (e.g., KYNAR of Atochem), vinylidene fluoride-perfluoroprypylene vinyl ether copolymer or the like is added to these organic solvents, and adding the following solutes, a gel polymer electrolyte can be formed.

As the solutes, it is preferable to use any one of more of the lithium salts having ClO₄—, CF₃SO₃—, BF₄—, PF₆—, AsF₆—, SbF₆—, CF₃CO₂—, (CF₃SO₂)₂N— and the like as the anion. In the above electrolyte solution or polymer electrolyte, it is preferable that an electrolyte consisting of a lithium salt of a concentration of 0.2 to 2.0 mol/L is added to the above solvent or solvent-containing polymer. If the concentration deviates from this range, the ion conductivity lowers, and the electric conductivity of the electrolyte lowers. More preferably, the range between 0.5 and 1.5 mol/L is selected. As the separator, a porous polyethylene or porous polypropylene film is used.

For the negative electrode material, a material that can store and discharge lithium ions is used. Although the material to form the negative electrode is not specifically limited, for example, lithium metal, lithium alloys, carbonaceous materials, oxides based on metals of 14 and 15 groups of the periodic table, carbon compounds, silicon carbide compounds, silicon oxide compounds, titanium sulfide, boron carbide compounds are included.

As carbon materials, pyrolyzed organic matter under various conditions, artificial graphite, natural graphite, soil graphite, expanded graphite, scale-like graphite, and the like can be used. As oxides, compounds based on tin oxide can be used. As negative collectors, copper foil, nickel foil and the like can be used.

It is preferable that the positive electrode and the negative electrode are obtained by kneading an active material and an organic solvent to form a slurry, and the slurry is applied to a metal foil collector, dried and pressed. The shape of the lithium battery is not specifically limited. A sheet shape (so-called film shape), a folded shape, a coil-type bottomed cylindrical shape, a button shape and the like are selected depending on the use.

### EXAMPLE 1

In a 2-L (liter) reaction vessel, ion-exchanged water was charged, and stirred at 400 rpm while maintaining the internal temperature at 50±1° C. To this, 0.4 L/hr of an aqueous solution of metal sulfate containing 1.5 mol/L of nickel sulfate, 1.5 mol/L of manganese sulfate, and 1.5 mol/L of cobalt sulfate; and 0.03 L/hr of an aqueous solution containing 1.5 mol/L of ammonium sulfate were simultaneously supplied; and an 18 mol/L caustic soda aqueous solution was successively supplied so as to maintain pH in the reaction vessel at 10.85±0.05. The slurry was concentrated until the final slurry concentration monitored by periodically extracting the mother liquor in the reaction vessel became about 720 g/L. After the target concentration is obtained, the slurry was aged at 50° C. for 5 hours, and filtration and water-washing were repeated to obtain spherical agglomerated particles of nickel-manganese-cobalt co-precipitated hydroxide having an average particle diameter of 9 μm.

To 60 parts by weight of an aqueous solution containing 0.071 mol/L potassium peroxodisulfate and 1 mol/L sodium hydroxide, 1 part by weight of the agglomerated particles of nickel-manganese-cobalt co-precipitated hydroxide were mixed, and stirred at 15° C. for 8 hours. After the reaction, filtration and water-washing were repeatedly performed, and the filtrate was dried to obtain the agglomerated particle powder of the nickel-manganese-cobalt co-precipitated oxyhydroxide, Ni_{1/3}Mn_{1/3}Co_{1/3}OOH.

By XRD diffraction spectra obtained from X-ray diffraction apparatus (Model RINT2100 manufactured by Rigaku Corporation) under the conditions of 40 kV-40 mA, a sampling interval of 0.020°, and a Fourier transform accumulated time of 2.0 seconds, a diffraction spectrum resembling the diffraction spectrum of CoOOH could be confirmed using a Cu—Kα line. The half-width of the diffraction peak of the agglomerated particles of a nickel-cobalt-manganese composite oxyhydroxide whose 2θ is in the vicinity of 19° in the X-ray diffraction using a Cu—Kα line was 0.400°. The average valence of the agglomerated particle powder of the nickel-manganese-cobalt co-precipitated oxyhydroxide obtained from the result of dissolving the agglomerated particle powder of the nickel-manganese-cobalt co-precipitated oxyhydroxide under the coexistence of Fe²⁺ in a 20% by weight aqueous solution of sulfuric acid, and titrating the solution using a 0.1 mol/L KMn₂O₇ solution, was 2.99; and it was confirmed to have an oxyhydroxide-based composition.

The average particle diameter of the agglomerated particle powder of the nickel-manganese-cobalt co-precipitated oxyhydroxide was 9 μm. The specific surface area measured using a BET method was 13.3 m²/g. It was understood from the SEM photograph of the powder that a large number of scale-like primary particles of 0.1 to 0.5 μm were agglomerated to form secondary particles. The powder compressed density obtained from the volume and weight of hydraulically compressed the agglomerated particle powder of the nickel-manganese-cobalt co-precipitated oxyhydroxide under a pressure of 0.96 t/Cm² was 2.18 g/cm³.

The agglomerated particle powder of the nickel-manganese-cobalt co-precipitated oxyhydroxide, the powder of lithium carbonate, and the powder of lithium fluoride were mixed, and fired in an atmosphere containing 40% by volume of oxygen at 900° C. for 10 hours, and pulverized to synthesize the powder of the composite oxide having an average particle diameter of 10.3 μm. As a result of the elemental analysis of the composite oxide, the composite oxide was Li_{1.04}Ni_{1/3}Mn_{1/3}Co_{1/3}O_{1.992}F_{0.008}.

The X-ray diffraction analysis of the powder was performed under the same conditions as the X-ray diffraction of the co-precipitated oxyhydroxide and as a result, it was found that the powder has an R-3m rhombohedral rock salt layered structure, the half-width of the diffraction peak of the (110) plane having a 2θ of 65±0.5° was 0.192°, and the half-width of the diffraction peak of the (003) plane having a 2θ of 19±1° was 0.148°. The specific surface area was 0.64 m²/g. The lattice constant of the a axis was 2.863 angstroms, and the lattice constant of the c axis was 14.240 angstroms. The breaking strength of the obtained composite oxide powder was measured using a micro compression testing machine MCT-W500 of Shimadzu Corporation. Specifically, 10 optional particles of known particle diameter were measured using a flat-type presser having a diameter of 50 μm under a testing load of 100 mN, and a load speed of 3.874 mN/sec, and the measured breaking strength was 106 MPa.

The Li_{1.04}Ni_{1/3}Mn_{1/3}Co_{1/3}O_{1.992}F_{0.008} powder was hydraulically compressed under a pressure of 0.96 t/Cm², and the powder compressed density was obtained from the volume and weight. The result was 3.00 g/cm³. The Li_{1.04}Ni_{1/3}Mn_{1/3}Co_{1/3}O_{1.992}F_{0.008} powder, acetylene black, and polyvinylidene fluoride with the weight ratio of 83/10/7 were mixed under addition of N-methyl pyrrolidone using a ball mill to be a slurry. The slurry was applied onto an aluminum positive collector with a thickness of 20 μm, and dried at 150° C. to remove the N-methyl pyrrolidone. Thereafter, they were compressed using a roll press to obtain a positive electrode body. A porous polyethylene with a thickness of 25 μm was used as the separator, a metallic lithium foil with a thickness of 300 μm was used as the negative electrode, a nickel foil was used as the negative electrode collector, and 1-M LiPF₆/EC+DEC (1:1) were used to assemble a 2030-type coin cell in an argon glove box.

Then, constant-current charging was performed to 4.3 V at 10 mA per gram of the positive electrode active material, constant-current discharging was performed to 2.7 V at 10 mA per gram of the positive active material, to conduct a charge-discharge test, and the discharge capacity and the charge-discharge efficiency at the initial charging and discharging were obtained; and a charge-discharge test was conducted at 150 mA/g to obtain the discharge capacity. For the battery safety evaluation under an atmosphere with a temperature of 25° C., the battery after 4.3-V charging was disassembled, the positive electrode was placed in a sealed container together with ethylene carbonate as the sample, and a differential scanning calorimeter was used to obtain the heat-generation peak temperature when elevating temperature was obtained. At 10 mA/g, the initial charge-discharge efficiency was 93.0% and the initial discharge capacity was 166 mAh/g; at 150 mA/g, the initial discharge capacity was 150 mAh/g; and the heat-generation peak temperature was 290° C.

### EXAMPLE 2

A positive electrode active material powder was synthesized in the same manner as in Example 1 except that the quantity of added lithium fluoride was increased in Example 1, and the powder properties and battery characteristics thereof were obtained. The average particle diameter of the positive electrode active material powder was 10.5 μm. The composite oxide was Li_{1.04}Ni_{1/3}Mn_{1/3}Co_{1/3}O_{1.968}F_{0.032}. As a result of X-ray diffraction analysis of the powder using Cu—Kα, it was found that the powder has an R-3m rhombohedral rock salt layered structure, the half-width of the diffraction peak of the (110) plane having a 2θ of 65±0.50 was 0.194°, and the half-width of the diffraction peak of the (003) plane having a 2θ of 19±1° was 0.140°. The specific surface area was 0.69 m²/g. The powder compressed density was 2.98 g/cm³. The lattice constant of the a axis was 2.862 angstroms, and the lattice constant of the c axis was 14.240 angstroms. The breaking strength of the particles of the composite oxide powder was 114 MPa. At 10 mA/g, the initial charge-discharge efficiency was 93.2% and the initial discharge capacity was 164 mAh/g; at 150 mA/g, the initial discharge capacity was 148 mAh/g; and the heat-generation peak temperature was 297° C.

### EXAMPLE 3

A positive electrode active material powder was synthesized in the same manner as in Example 1 except that the aluminum fluoride was added in place of lithium fluoride in Example 1, and the powder properties and battery characteristics thereof were obtained. The average particle diameter of the positive electrode active material powder was 11.1 μm. The composite oxide was Li_{1.04}(Ni_{1/3}Co_{1/3}Mn_{1/3})_{0.995}Al_{0.005}O_{1.99}F_{0.01}. As a result of X-ray diffraction analysis of the powder using Cu—Kα, it was found that the powder has an R-3m rhombohedral rock salt layered structure, the half-width of the diffraction peak of the (110) plane having a 2θ of 65±0.5° was 0.205°, and the half-width of the diffraction peak of the (003) plane having a 2θ of 19±1° was 0.137°. The specific surface area was 0.52 m²/g. The powder compressed density was 2.93 g/cm³. The lattice constant of the a axis was 2.863 angstroms, and the lattice constant of the c axis was 14.250 angstroms. The breaking strength of the particles of the composite oxide powder was 111 MPa. At 10 mA/g, the initial charge-discharge efficiency was 92.8% and the initial discharge capacity was 164 mAh/g; at 150 mA/g, the initial discharge capacity was 149 mAh/g; and the heat-generation peak temperature was 282° C.

### EXAMPLE 4

A positive electrode active material powder was synthesized in the same manner as in Example 1 except that the magnesium fluoride was added in place of lithium fluoride in Example 1, and the powder properties and battery characteristics thereof were obtained. The average particle diameter of the positive electrode active material powder was 10.6 μm. The composite oxide was Li_{1.04}(Ni_{1/3}Co_{1/3}Mn_{1/3})_{0.99}Mg_{0.01}O_{1.99}F_{0.01}. As a result of X-ray diffraction analysis of the powder using Cu—Kα, it was found that the powder has an R-3m rhombohedral rock salt layered structure, the half-width of the diffraction peak of the (110) plane having a 2θ of 65±0.5° was 0.180°, and the half-width of the diffraction peak of the (003) plane having a 2θ of 19±1° was 0.138°. The specific surface area was 0.48 m²/g. The powder compressed density was 2.98 g/cm³. The lattice constant of the a axis was 2.863 angstroms, and the lattice constant of the c axis was 14.242 angstroms. The breaking strength of the particles of the composite oxide powder was 115 MPa. At 10 mA/g, the initial charge-discharge efficiency was 93.2% and the initial discharge capacity was 161 mAh/g; at 150 mA/g, the initial discharge capacity was 152 mAh/g; and the heat-generation peak temperature was 279° C.

### COMPARATIVE EXAMPLE 1

A positive electrode active material powder was synthesized in the same manner as in Example 1 except that lithium fluoride was not added in Example 1, and the powder properties and battery characteristics thereof were obtained. The average particle diameter of the positive electrode active material powder was 9.5 μm. The composite oxide was Li_{1.04}Ni_{1/3}Mn_{1/3}Co_{1/3}O₂. As a result of X-ray diffraction analysis of the powder using Cu—Kα, it was found that the powder has an R-3m rhombohedral rock salt layered structure, the half-width of the diffraction peak of the (110) plane having a 2θ of 65±0.5° was 0.290, and the half-width of the diffraction peak of the (003) plane having a 2θ of 19±1° was 0.201°. The specific surface area was 0.45 m²/g. The powder compressed density was 2.76 g/cm³. The lattice constant of the a axis was 2.862 angstroms, and the lattice constant of the c axis was 14.240 angstroms. The breaking strength of the particles of the composite oxide powder was 105 MPa. At 10 mA/g, the initial charge-discharge efficiency was 90.4% and the initial discharge capacity was 162 mAh/g; at 150 mA/g, the initial discharge capacity was 143 mAh/g; and the heat-generation peak temperature was 239° C.

### INDUSTRIAL APPLICABILITY

According to the present invention, a lithium secondary battery that can be used in a wide voltage range, that has high initial charge-discharge efficiency, weight capacity density and volume capacity density, that excels in large-current charging characteristics, and that excels in safety and availability, can be realized.

1. A lithium-nickel-cobalt-manganese-fluorine-containing composite oxide having an R-3m rhombohedral structure represented by a general formula LipNixMn1-x-yCoyO2-qFq (where 0.98≦p≦1.07, 0.3≦x≦0.5, 0.1≦y≦0.38, and 0≦q≦0.05), characterized in that the half-width of the diffraction peak of a (110) plane whose 2θ is 65±0.5° in the X-ray diffraction using a Cu—Kα line is 0.12 to 0.25°.

2. The lithium-nickel-cobalt-manganese-fluorine-containing composite oxide according to claim 1, wherein the specific surface area is 0.3 to 1.0 m2/g.

3. The lithium-nickel-cobalt-manganese-fluorine-containing composite oxide according to claim 1, wherein q is 0.001 to 0.02.

4. The lithium-nickel-cobalt-manganese-fluorine-containing composite oxide according to claim 1, wherein the powder compressed density is 2.9 to 3.4 g/cm2.

5. The lithium-nickel-cobalt-manganese-fluorine-containing composite oxide according to claim 1, wherein the breaking strength is 50 MPa or more.

6. The lithium-nickel-cobalt-manganese-fluorine-containing composite oxide according to claim 1, wherein 0.1 to 10% of the total number of nickel, cobalt and manganese is substituted by at least one of aluminum, magnesium, zirconium and titanium.

7. A method for preparing the lithium-nickel-cobalt-manganese-fluorine-containing composite oxide according to claim 1, whereby including a step for dry-blending the agglomerated particles of a nickel-cobalt-manganese composite oxyhydroxide, lithium carbonate and a fluorine-containing compound, and a step for firing the particles in an oxygen-containing atmosphere.

8. The method for preparing the lithium-nickel-cobalt-manganese-fluorine-containing composite oxide according to claim 7, wherein the specific surface area of the nickel-cobalt-manganese agglomerated composite oxyhydroxide is 4 to 30 m2/g.

9. The method for preparing the lithium-nickel-cobalt-manganese-fluorine-containing composite oxide according to claim 7, wherein the powder compressed density of the nickel-cobalt-manganese-containing composite oxyhydroxide is 2.0 g/cm3 or more.

10. The method for preparing the lithium-nickel-cobalt-manganese-fluorine-containing composite oxide according to claim 7, wherein the half-width of the diffraction peak of the agglomerated particles of a nickel-cobalt-manganese agglomerated composite oxyhydroxide whose 2θ is 19±1° in the X-ray diffraction using a Cu—Kα line, is 0.3 to 0.5°.

11. A lithium secondary battery wherein the lithium-nickel-cobalt-manganese-fluorine-containing composite oxide according to claim 1 is used as the positive electrode.

12. A lithium secondary battery wherein lithium-nickel-cobalt-manganese-fluorine-containing composite oxide prepared using a preparing method according to claim 7 is used as the positive electrode.
